(19) United States
(12) Patent Application Publication
(10) Pub. No.: US 2005/0246660 A1
(43) Pub. Date: Nov. 3, 2005

(54) Menu control

(75) Inventor: Bjorn Fehrm, Planegg (DE)

Correspondence Address: COHEN, PONTANI,;LIEBERMAN & PAVANE, 551 Fifth Avenue, Suite 1210, New York, NY, 10176, US

(73) Assignee: Fujitsu Siemens Computers GmbH, Domagkstrasse (DE)

(21) Appl. No.: 11/101,818

(22) Filed: Apr. 7, 2005

Related U.S. Application Data
(63) Continuation of application No. PCT/DE03/03100, filed on Sep. 18, 2003.

(30) Foreign Application Priority Data
Oct. 7, 2002 (DE) 102 46 629.7
Dec. 10, 2002 (DE) 202 19 128.1

(51) Int. Cl. G06F 3/00

(52) U.S. Cl. 715/810; 715/792

(57) ABSTRACT

A menu control for an electrical appliance having a screen menu (1) which is subdivided into an information area (2), a list area (3) for menu objects and a command area (4) for menu commands.

### RELATED APPLICATIONS

This is a continuation of International Application No. PCT/DE2003/003100, filed on Sep. 18, 2003, which claims priority from U.S. German application nos. 102 46 629.7 and 202 19 128.1 filed Oct. 7, 2002 and Dec. 10, 2002, respectively the contents of which is hereby incorporated by reference.

### FIELD OF THE INVENTION

The invention relates to menu control for electrical appliances having a screen menu which can be operated by means of four direction buttons and a selection button.

### BACKGROUND OF THE INVENTION

Menu controls, which can be operated by means of a so-called navigation button with four direction buttons and a selection button are known, for example, from mobile telephone controllers from Sony and Nokia, and from menu controls for televisions and video recorders.

Many different menu control designs have been developed, with the differences relating to the functions of the particular electrical appliance. Particularly when an appliance has a large number of functions, the menu controls are complex and unclear, and can be understood only by detailed study of the manual and with guidance based on the manual. For those who are not so technically competent, generally older people, this often presents a major problem. In consequence, many functions of the appliances cannot be used since they can be accessed only by means of complicated menu guidance.

The traditional design of a menu for menu control is generally hierarchical. This design is very simple to understand and to operate.

FIGS. 5 and 6 schematically show one such hierarchal design. As illustrated in FIG. 5, the menu objects are listed one above the other, and the focus is in each case directed at one menu object. In FIG. 5, the focus is represented by a bold border on the menu object. If one wishes to select this menu object, then the OK or selection button is pressed on the remote control. The focus can then be moved upward or downward to another menu object by means of the direction buttons in order to select a different menu object.

In order to reach a lower menu level, it is generally necessary to press the OK or selection button on the remote control. This procedure is repeated until the menu level is reached in which the menu item for the desired action is listed. In order to make it possible to jump to a higher menu level again, an EXIT button is generally provided on the remote control. For operation of the EXIT button, it is possible to jump upward again by one menu level in each case. By way of example, FIG. 6 shows a hierarchical design such as this with three menu levels.

This therefore results in a large number of menu levels, in which case the user must virtually know by heart what actions can be carried out in which menu level.

In order to avoid this and to allow specific commands to be carried out directly or else additionally, additional function buttons are generally also provided on the remote control, in addition to the navigation button, via which the menu commands that are used frequently can be carried out directly. This means that systems with a large number of functions are delivered with remote controls which have a large number of function buttons, often in the form of multifunctional buttons, which are difficult to understand and are likewise also difficult to operate in the dark, in a television room.

### SUMMARY OF THE INVENTION

One object of the invention is to provide a simple and clearly structured menu control which solves not only the problem of the large number of hierarchical levels, but also of the large number of function buttons on a remote control.

This and other objects are attained in accordance with one aspect of the present invention directed to a menu control for electrical appliances having a screen menu which can be operated by means of direction buttons and a selection button (9). The screen menu has a list area for menu objects, and a command area for the menu commands for the selected menu object.

It is also possible to arrange an information area above the list area and the command area, in order to indicate the date and time, and/or other information such as an explanation of the list area that is currently selected.

The advantage of this menu control is that it comprises only the list area and the command area, so that all the menu objects and menu commands can be carried out using one navigation button with four direction buttons and one selection button.

There is no need to understand complicated button symbols or multifunction buttons, since every menu command can be carried out just using the navigation button.

The major advantage of this menu control is that the user is presented with the same menu control for all the appliance functions, and can thus move quickly and simply in the menu hierarchy. The user will find all the menu objects in the list area, and can use the command area to select which menu commands he or she wishes to carry out for that menu object.

In addition, two or more menus may be listed as menu objects in the list area, with the capability then appearing in the command area to select the menu or to retrieve only information relating to that menu.

All the controls for the functions of the appliance can thus be carried out using the same menu guidance. A further advantage results from the fact that the area subdivision into information, list and command areas on the screen always remains the same, namely that the user is not confused by a different graphical representation.

The screen menu is preferably controlled using a remote control, but this can also be done by means of a keyboard or by means of a navigation button directly on the appliance.

According to one development of the invention, further buttons are arranged on the remote control and can be associated directly with menu objects in the list area and/or menu commands in the command area, with the symbol for the button on the remote control in each case being overlaid on the respective menu object or menu command.

The buttons can be programmed to make it possible for any user to address directly the functions which are used frequently by him or her, such as with a well-known hot-key feature which is not a feature of the invention.

Selected menu objects in the list area and/or menu commands in the command area are preferably on a colored background or are graphically emphasized, so that the user can in each case immediately see the menu area in which he or she is located.

The design of the menu control makes it possible to operate all appliance functions via the list and command areas using the same scheme.

The menu control is thus excellently suitable for a set top box which has a television, video recorder, Internet and mail function, as well as a DVD and CD player.

### BRIEF DESCRIPTION OF THE DRAWINGS

FIG. 1 shows the general organization of the screen area and a remote control,

FIGS. 2 and 3 show the view shown in FIG. 1, in different hierarchical levels,

FIG. 4 shows the view as in FIG. 3 with programmable function buttons on the remote control, which can be associated with menu instructions.

FIG. 5 shows a hierarchical arrangement according to the prior art,

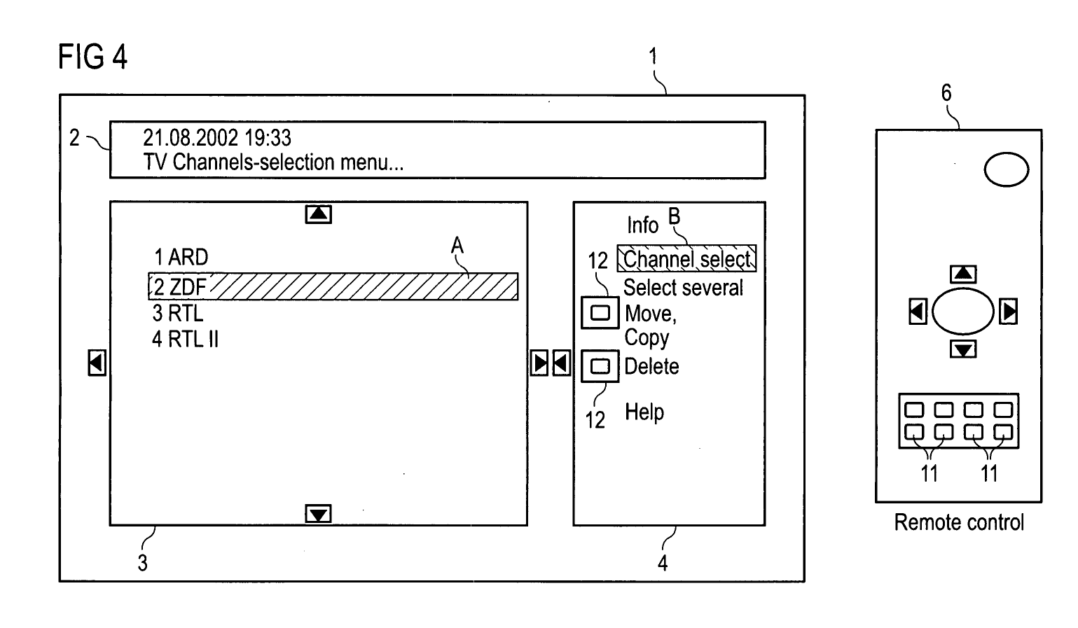

FIG. 6 shows a number of screen menus based on a hierarchical configuration according to the prior art, and

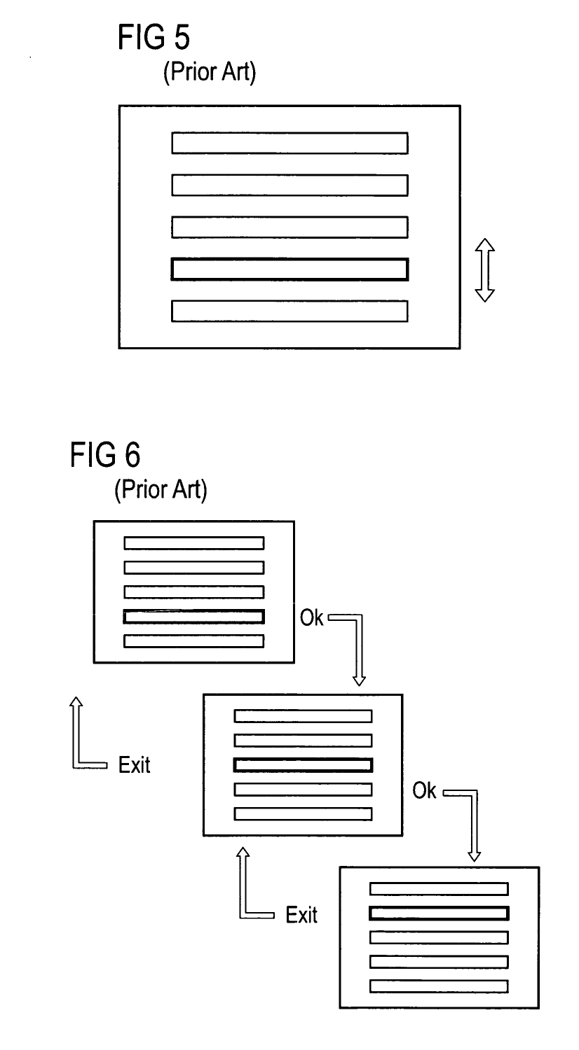

FIG. 7 shows the screen menus for the menu control according to the invention.

### DETAILED DESCRIPTION OF THE DRAWINGS

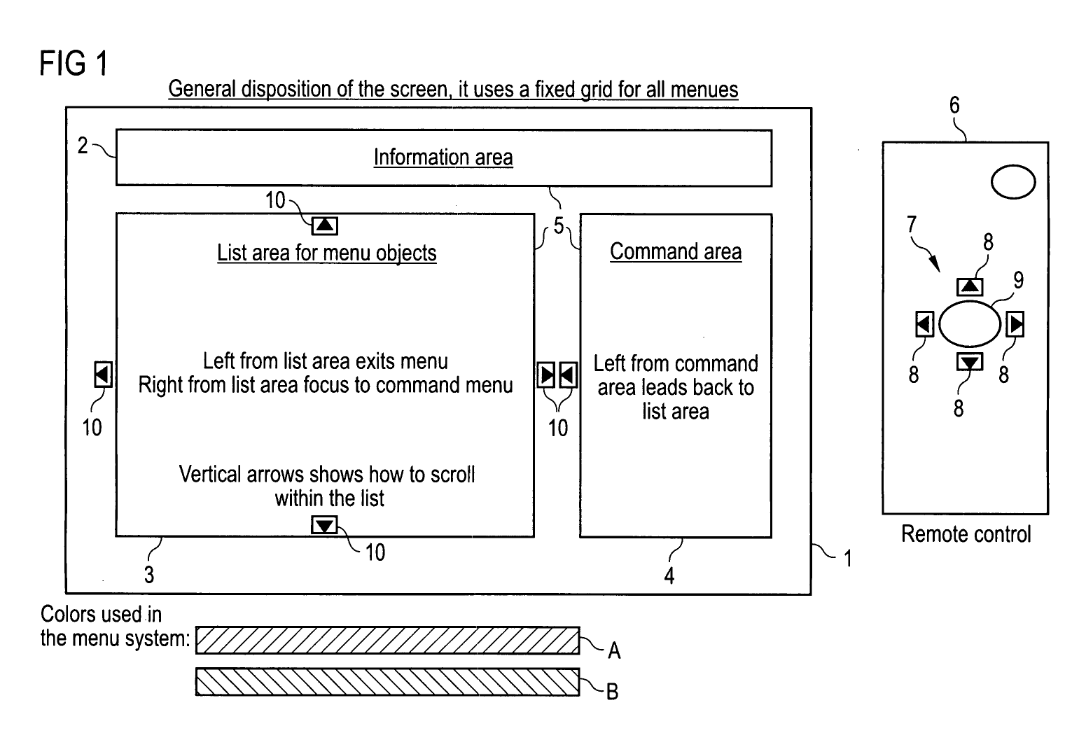

FIG. 1 shows a screen menu 1 as may be used, for example, for menu control for a set top box. The screen menu 1 has three areas, namely an information area 2, a list area 3 and an instruction area 4. All three areas each have a solid border 5, so that the visual appearance of the basic configuration does not change, and only the content of the areas 2, 3 and 4 changes.

The controls for that content within the list area 3 and the command area 4, as well as the controls to change from the command area 4 to the list area 3, and vice versa, are in a remote control device 6 which has at least one navigation button 7 with four direction buttons 8 and a selection button 9.

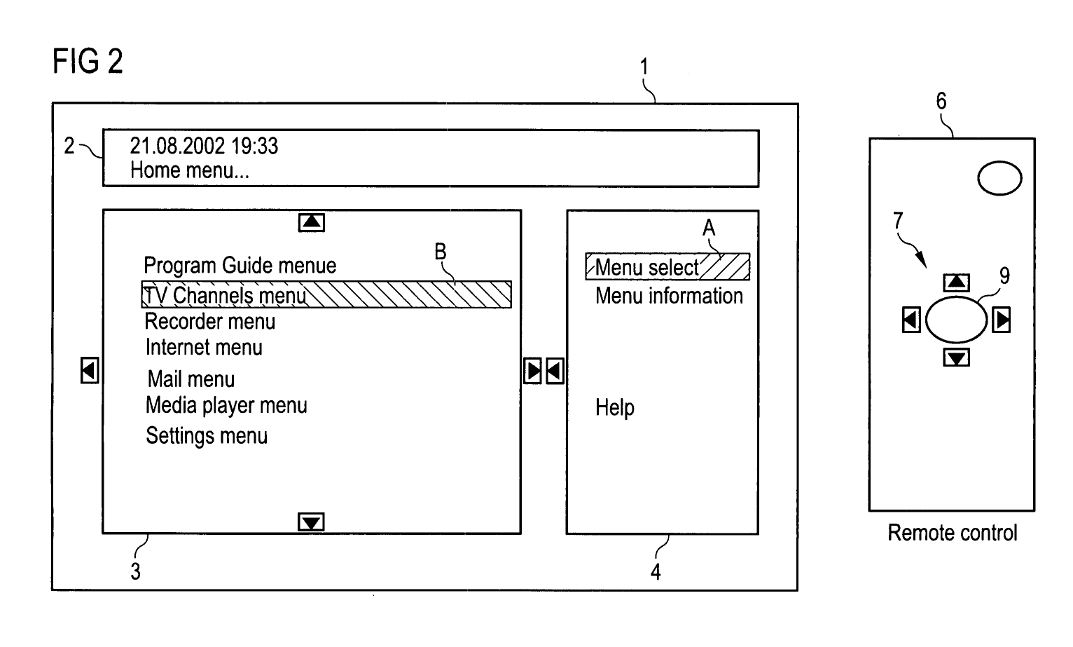

The change between the list area 3 and the instruction area 4 is made using the horizontal direction buttons 8, with the operation of the left direction button 8 in the list area 3 resulting in a jump being made to the next “up” main menu, and with the right direction button 8 a jump is made to the next “down” menu. Main menu are the menus shown in list area 3 in FIGS. 2 and 3. Thus, FIG. 2 shows a main menu called “Home menu” (see information area 2), and FIG. 3 shows a main menu called “TV Channels-selection menu”.

Direction buttons 10 are likewise overlaid on the screen menu 1 and illuminate when the corresponding direction button 8 is operated on the remote control 6.

Active areas are likewise shown on a background in the color A, and selected areas, but areas which are no longer active are shown with a color B. Further details are explained in the following figures.

By way of example, FIG. 2 shows a screen menu 1 for a set top box, with the information area 2, the list area 3 and the instruction area 4. The menu object “TV channels menu” is shown on a background in the color B in the list area 3, indicating that this menu object is selected, but is no longer the focus here.

The focus (which is a frame that is movable like a cursor) is now located in the instruction area 4, with the “Menu select” object being active, and being shown on a background in the color A.

The “TV channels menu” can be selected via “Menu select” in the instruction area 4 by operation of the selection button 9 on the remote control 6. The screen display illustrated in FIG. 3 then appears. The list area 3 with the color A is now once again automatically active, via which vertical cursor buttons 8 can be used to change channel, with the selection being made via channel select in the instruction area 4.

If specific menu objects, such as the “TV channels menu” in FIG. 2 or, for example, ZDF [the second German television station] in FIG. 3 are addressed relatively frequently, it is possible to preset the position of the cursor or the colored background in the list area 3 on a respective menu object or in the instruction area 4 on the respective menu instruction, so that there is no need to scroll to the preferred menu object or menu instruction when calling up the corresponding menu area.

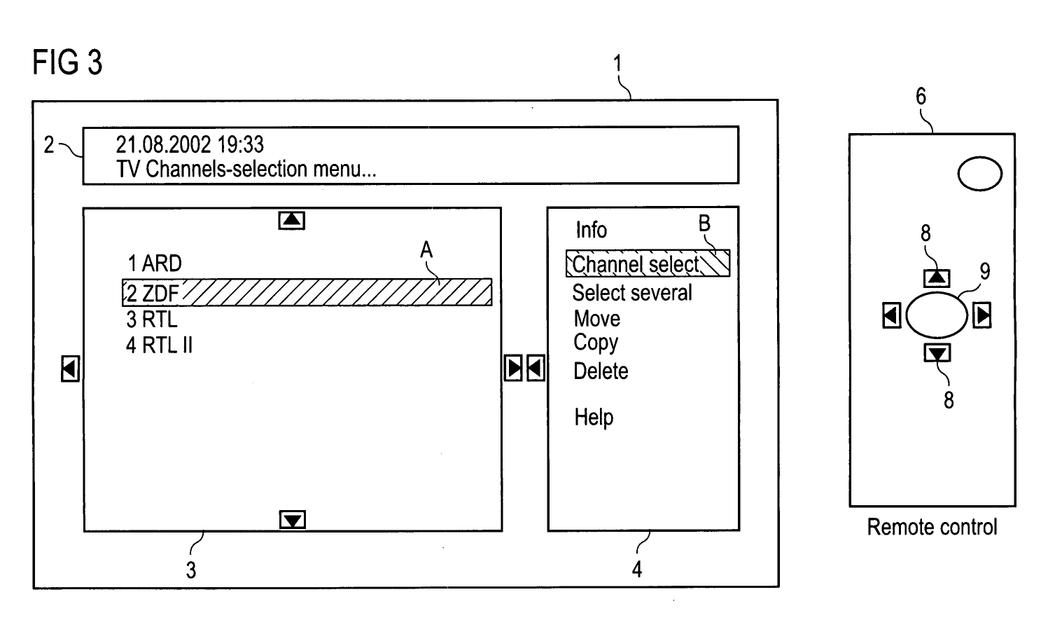

FIG. 4 shows the same illustration as that in FIG. 3 with a refinement in which function buttons 11 are arranged on the remote control 6 and can be associated with individual instructions in the instruction area 4. Each function button 11 has a unique symbol, such as a specific color.

The symbols for the function buttons 11 are displayed as image symbols 12 alongside the associated instructions, based on the association.

The menu control according to the invention avoids the disadvantages of conventional hierarchical menu control by reducing the number of function buttons to an absolute minimum because all functions could be operated via the list and command areas, and also reducing the steps for movement of the focus in order to obtain the desired menu instructions.

Any change in the hierarchy level is possible by operation of the selection button when the focus for the menu instructions is on the desired instruction or on the menu instruction, when the aim is to select the next hierarchy level. Otherwise, the change in the hierarchy level is possible by the operation of the left direction button in the list area.

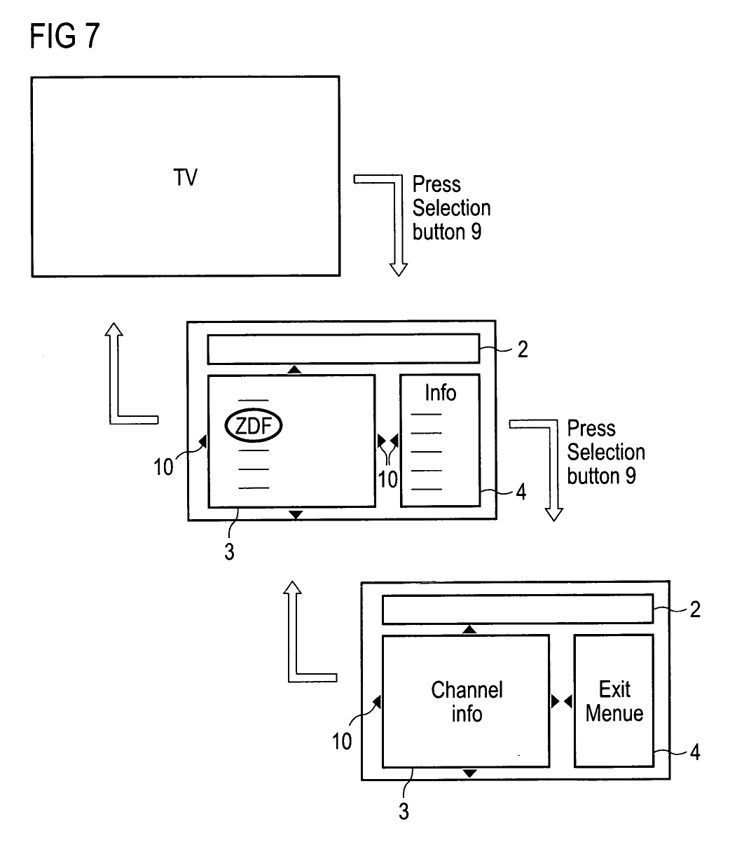

FIG. 7 shows an exemplary embodiment of the menu control as illustrated in FIGS. 1 to 4.

The drawing shows the situation in which television is being watched in the normal way and the viewer wishes to obtain information about the film that is currently being watched. The first screen shows the television program which is currently being watched, shortened to TV. Pressing the selection button 9 on the remote control results in switching to the first page of the illustrated menu control. The focus in the list area 3 is automatically on the list area menu object which is currently active. In the illustrated exemplary embodiment, this is the ZDF program. All the menu instructions which are available for the list instruction ZDF are listed in the instruction area 4. If, by way of example, information is desired about the current program, then the focus is moved to the “Info” menu instruction by operation of the direction button 8 on the remote control, corresponding to the illustrated direction arrows 10 on the screen menu.

Pushing the selection button 9 results in information about the current program appearing in the list area 3. In order to leave the list area 3 or this hierarchy level, it is either possible to jump upwards by operation of the left direction button by one hierarchy level by operation of the left direction button, or to select the instruction EXIT MENU in the instruction area 4 by operation of the right direction button, and likewise to jump to the next hierarchy level by pushing the selection button.

The menu control according to an embodiment of the invention is thus an improvement of conventional hierarchical menu controls, and provides the following four main improvements:

a) efficient navigation among the hierarchy levels,

b) assignment of different explicit menu instructions for the selection button 9 or the OK button,

c) implementation of the entire menu control with a minimum number of button pushing operations and a minimum level of menu complexity, and

d) avoidance of non-explicit methods, which are used to obtain more flexibility for carrying out menu instructions.

By way of example, the red, green, blue or yellow buttons on a remote control may be mentioned as non-explicit methods, which have a different function in conjunction with the respective menu that is displayed on the screen. In order to allow the buttons or the functions to be used, the user must combine the color and the instructions, as follows.

1. The user places the focus on an object in the menu control,

2. The user can read how the menu object can be carried out, in the area of the menu system where the instruction is described,

3. Identification of the color which is assigned to the respective menu instruction,

4. Identification of the button with the appropriate color on the remote control,

5. Operation of the button and observation of the change on the screen, as to what effect has been achieved with the button that has been operated.

All of this can be omitted with the menu control according to the invention, since the navigation button can be operated without looking at it using the four direction buttons and the selection button, so that the eyes always remain on the screen.

The menu control is thus ideally suited for a set top box which combines a large number of functions, such as television, DVD, video recorder, Internet mail and media players.

The Activy device and associated software are available from Fujitsu Siemens Computers and can perform the above-described features related to the invention. Manuals and other descriptive literature on the Activy device and software are hereby incorporated by reference.

The scope of protection of the invention is not limited to the examples given hereinabove. The invention is embodied in each novel characteristic and each combination of characteristics, which includes every combination of any features which are stated in the claims, even if this combination of features is not explicitly stated in the claims.

1. A menu control for electrical appliances having a screen menu (1) which can be operated by means of direction buttons (8) and a selection button (9),
wherein
the screen menu has a list area (3) for menu objects, and an instruction area (4) for the menu instructions for the selected menu object.

2. The menu control as claimed in claim 1,
wherein
the screen menu (1) furthermore has an information area (2).

3. The menu control as claimed in claim 1,
wherein
the subdivision of the screen menu into an information area (2), a list area (3) and an instruction area (4) remains unchanged in all hierarchy levels.

4. The menu control as claimed in claim 1,
wherein
the control function is carried out using a remote control, and the direction buttons (8) as well as the selection button (9) are arranged on the remote control (6), in the form of a navigation button (7).

5. The menu control as claimed in claim 1,
wherein
a lower hierarchy level can be reached by selection of the corresponding menu instruction and operation of the selection button (9), and a higher hierarchy level can be reached by operation of the left direction button (8) in the list area (4).

6. The menu control as claimed in claim 4,
wherein
function buttons (11) are arranged on the remote control (6) and can be associated with menu objects in the list area (3) and/or menu instructions in the instruction area (4), with the symbol (12) for the function button (11) in each case being overlaid alongside the menu object or menu instruction.

7. The menu control as claimed in claim 1,
wherein
the selected menu objects and/or menu instructions are marked in colors and/or are graphically emphasized, and active menu objects and/or menu instructions are graphically offset, in color or graphically, from the selected menu objects or instructions.

8. The menu control as claimed in claim 1,
wherein
substantially all appliance functions can be operated via the list area (3) and the instruction area (4) using the same scheme.

9. The menu control as claimed in claim 1,
wherein
the menu control is used for a set top box.

10. A menu control method for electrical appliances having a screen menu (1) which can be operated by means of direction buttons (8) and a selection button (9), comprising:
providing a screen menu arrangement having a list area (3) for menu objects and a command area (4) for menu commands for a selected menu object, and
operating substantially all menu-controllable appliance functions with the direction buttons (8) and the selection button (9) via the list area (3) and the command area (4), using the same screen menu arrangement.
